(19) United States
(12) Patent Application Publication
(10) Pub. No.: US 2014/0267143 A1
(43) Pub. Date: Sep. 18, 2014

(54) SYSTEM AND METHOD FOR A TRANSCAPACITIVE PROXIMITY SENSING DEVICE

(71) Applicant: SYNAPTICS INCORPORATED, Santa Clara, CA (US)

(72) Inventors: Patrick Worfolk, Campbell, CA (US); Adam Schwartz, Redwood City, CA (US); Mihai Bulea, Santa Clara, CA (US)

(73) Assignee: SYNAPTICS INCORPORATED, Santa Clara, CA (US)

(21) Appl. No.: 13/887,398

(22) Filed: May 6, 2013

Related U.S. Application Data
(60) Provisional application No. 61/798,901, filed on Mar. 15, 2013.

(51) Int. Cl. G06F 3/044

(52) U.S. Cl. CPC G06F 3/044
USPC 345/174

(57) ABSTRACT

A processing system for a transcapacitive input device configured to detect input objects in a sensing region of the input device includes a transmitter module including transmitter circuitry, a receiver module, and a determination module. The transmitter module is configured to simultaneously transmit, using a plurality of transmitter electrodes, a plurality of transmitter signals according to a plurality of significantly non-orthogonal digital codes. At least two codes of the plurality of significantly non-orthogonal digital codes are significantly non-orthogonal. The receiver module is configured to receive, with a plurality of receiver electrodes, a plurality of resulting signals. Each resulting signal of the plurality of resulting signals comprises multiple effects corresponding to multiple transmitter signals of the plurality of transmitter signals. The determination module is configured to determine object information for input in the sensing region using the plurality of resulting signals.

### CROSS-REFERENCE TO RELATED APPLICATIONS

This application claims the benefit of U.S. Prov. Pat. App. No. 61/798,901, filed Mar. 15, 2013, the contents of which are hereby incorporated by reference.

### FIELD OF THE INVENTION

This invention generally relates to electronic devices, and more specifically relates to sensor devices.

### BACKGROUND OF THE INVENTION

Input devices including proximity sensor devices (also commonly called touchpads, position sensing devices, or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers).

Conventional transcapacitive touch sensor devices comprise a plurality of transmitter electrodes extending along a first axis, and a plurality of receiver electrodes extending along a second axis orthogonal to the first axis. These pluralities of transmitter and receiver electrodes define a grid of cross-over locations at which changes in capacitive coupling due to nearby input can be determined by the sensor device. Readings corresponding with the change in capacitive coupling at the cross-over locations can be used to form a capacitive image of input (or lack of input) near the sensor device. Conventional transcapacitive touch sensor devices typically obtain such capacitive images by transmitting with the transmitter electrodes in a sequential way, such that only one transmitter electrode transmits at any one time. This capacitive image can be operated upon by conventional image processing techniques to determine information about the input (or lack thereof) near the sensor device.

Conventional transcapacitive touch sensor devices often have difficulty detecting or determining information about certain types of input. For example, many conventional transcapacitive touch sensor devices have trouble sensing input that changes the capacitive coupling between the transmitter and receiver electrodes in a weak way, such as “hovering fingers” for particular systems. (“Hovering fingers” refers to fingers of a human hand disposed in a non-contact manner over the sensor electrodes.) With conventional transcapacitive touch sensor devices, such weak capacitance changes tend to produce relatively weak signals, and known methods for addressing such weak signals are undesirable in a number of respects. Accordingly, there is a need for systems and methods that improve the detection and information determination for these types of input (including those that generate weak signals and those that are challenging in other respects), and to improve the user experience of proximity sensing devices.

### BRIEF SUMMARY OF THE INVENTION

In accordance with one embodiment, a transcapacitive sensor device comprises a plurality of transmitter electrodes, a plurality of receiver electrodes capacitively coupled with the plurality of transmitter electrodes, and a processing system. The processing system is communicatively coupled to the plurality of transmitter electrodes and the plurality of receiver electrodes. The processing system is configured to transmit, with the plurality of transmitter electrodes, a plurality of transmitter signals in accordance with a plurality of significantly non-orthogonal digital codes. At least two codes of the plurality of significantly non-orthogonal digital codes are significantly non-orthogonal. The processing system is also configured to receive, with the plurality of receiver electrodes, a plurality of resulting signals. Each resulting signal of the plurality of resulting signals comprises multiple effects corresponding to multiple transmitter signals of the plurality of transmitter signals. The processing system is further configured to determine one or more positions for input near the pluralities of transmitter and receiver electrodes based on a comparison of the plurality of resulting signals with a family of expected signals. The comparison involves determining correlation amounts between the plurality of resulting signals and different members of the family of expected signals, and determining a highest correlation or a set of correlations past a threshold correlation amount based on the correlation amounts.

In accordance with one embodiment, a processing system for a transcapacitive input device configured to detect input objects in a sensing region of the input device comprises a transmitter module including transmitter circuitry, a receiver module, and a determination module. The transmitter module is configured to simultaneously transmit, using a plurality of transmitter electrodes, a plurality of transmitter signals according to a plurality of significantly non-orthogonal digital codes. At least two codes of the plurality of significantly non-orthogonal digital codes are significantly non-orthogonal. The receiver module is configured to receive, with a plurality of receiver electrodes, a plurality of resulting signals. Each resulting signal of the plurality of resulting signals comprising multiple effects corresponding to multiple transmitter signals of the plurality of transmitter signals. The determination module is configured to determine object information for input in the sensing region using the plurality of resulting signals.

A method in accordance with one embodiment for detecting input objects in a sensing region of a transcapacitive input device comprising a plurality of transmitter electrodes and a plurality of receiver electrodes is disclosed. The method comprises simultaneously transmitting, with the plurality of transmitter electrodes, a plurality of transmitter signals in accordance with a plurality of significantly non-orthogonal digital codes. At least two codes of the plurality of significantly non-orthogonal digital codes are significantly non-orthogonal. The method also comprises: receiving, with the plurality of receiver electrodes, a plurality of resulting signals. Each resulting signal of the plurality of resulting signals comprising multiple effects corresponding to multiple transmitter signals of the plurality of transmitter signals. The method further comprises determining object information for input in the sensing region based on a comparison of the resulting signals to a family of expected signals.

### BRIEF DESCRIPTION OF DRAWINGS

The present invention will hereinafter be described in conjunction with the appended drawings, where like designations denote like elements, and:

FIG. 1 is a block diagram of an example system that includes an input device in accordance with an embodiment of the invention;

FIG. 2 is a conceptual block diagram depicting an example electrode pattern;

FIG. 3 depicts a processing system in accordance with one embodiment;

FIG. 4 is a graphical depiction of an example template;

FIG. 5 is a graphical depiction of expected signals for the example template of FIG. 4 in association with a plurality of transmitter signals transmitted in accordance to a plurality of significantly non-orthogonal digital codes; and

FIG. 6 is a flowchart depicting a method in accordance with one embodiment.

### DETAILED DESCRIPTION OF THE INVENTION

The following detailed description presents a number of example embodiments and is not intended to limit the invention or the application and uses of the invention. Furthermore, there is no intention to be bound by any expressed or implied theory presented in the preceding technical field, background, brief summary, or the following detailed description.

Various embodiments of the present invention provide input devices and methods that facilitate improved usability. FIG. 1 is a block diagram of an example input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be substantially uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

FIG. 2 illustrates, conceptually, an example set of capacitive sensor electrode pattern 200 configured to sense in a sensing region. For clarity of illustration and description, FIG. 2 shows a first set of elongated, rectangular sensor electrodes 210 (210A-F) arranged in a first direction, and a second set of elongated, rectangular sensor electrodes 220 (220A-F) arranged in a second direction substantially perpendicular to the first direction. It will be appreciated, however, that FIG. 2 shows a non-limiting example, and a variety of sensor electrode pattern—including ones that vary in sensor electrode layout, size, shape, number, material, and the like—may be suitable in various embodiments.

In sensor electrode pattern 220, sensor electrode 220A is adjacent to sensor electrode 220B, sensor electrode 220B is adjacent to both sensor electrode 220A and sensor electrode 220C. A group of adjacent sensor electrodes can bet termed a contiguous set of sensor electrodes. Thus, sensor electrodes 220A-D is a contiguous set of sensor electrodes, as are sensor electrodes 210B-C or 210B-E.

In sensor electrode pattern 200, sensor electrodes 210 and 220 of FIG. 2 are ohmically isolated from each other. In some embodiments, sensor electrodes 210, 220 are disposed as a single layer of conductive material on a substrate that are connected by electrical jumpers as appropriate; the sensor electrodes 210, 220 are separated from each other by local dispositions of insulative material disposed between the regions where a sensor electrode 210 overlaps with a sensor electrode 220. The insulative material may comprise one or more patches of insulative material that are printed, sputtered, or otherwise patterned. In some embodiments, sensor electrodes 210, 220 are separated by one or more substrates. For example, sensor electrodes 210 may be disposed on an first surface of a substrate, and sensor electrode 220 may be disposed on a second, opposite surface of the same substrate. As another example, sensor electrodes 210, 220 may be disposed on different substrates that are laminated together.

In one embodiment, sensor electrodes 210 and 220 are constructed from opaque or substantially opaque conductive materials. In other embodiments, sensor electrodes 210 and 220 are constructed in whole or in part from substantially transparent conductive material, such as patterned ITO, ATO, carbon nanotubes, or other substantially transparent materials.

In a transcapacitive embodiment of the sensor electrode pattern 220, sensor electrodes 220A-F are configured as receiver electrodes, and sensor electrodes 210A-F are configured as transmitter electrodes. That is, sensor electrodes 220, 210 are communicatively coupled with a processing system that operates them to receive or transmit as appropriate. In some embodiments, sensor electrodes 220, 210 are also shaped for better performance as receiver or transmitter electrodes. The capacitive coupling between the transmitter electrodes and receiver electrodes change with input near sensor electrode pattern 220, in the sensing region associated with sensor electrode pattern 220. Referring again to FIG. 1, a processing system 110 is shown as part of the input device 100. The processing system 110 is configured to operate the hardware of the input device 100 (including, for example, the various sensor electrodes 200 of FIG. 2) to detect input in the sensing region 120. The processing system 110 comprises parts of or all of one or more integrated circuits (ICs) and/or other circuitry components. For example, as described in further detail below, a processing system for a mutual capacitance sensor device may comprise transmitter circuitry configured to transmit signals with transmitter sensor electrodes, and/or receiver circuitry configured to receive signals with receiver sensor electrodes).

In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like. In one embodiment, processing system 110 includes determination circuitry configured to determine positional information for an input device based on the measurement.

“Positional information” as used herein broadly encompasses absolute position, relative position, velocity, acceleration, and other types of spatial information. Example “zero-dimensional” positional information includes near/far or contact/no contact information. Example “one-dimensional” positional information includes positions along an axis. Example “two-dimensional” positional information includes motions in a plane. Example “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

Referring now to the conceptual block diagram depicted in FIG. 3, an example processing system 310 for a transcapacitive input device comprising a plurality of transmitter electrodes and a plurality of receiver electrodes is illustrated. The transcapacitive input device is configured to detect input objects in a sensing region of the input device in accordance with one embodiment. In some embodiments, processing system 310 is an implementation of the processing system 110 of FIG. 1. Processing system 310 generally includes a transmitter module 304, a receiver module 306, and a determination module 308. Processing system 310 is communicatively coupled to a set of sensor electrodes 302. Specifically, in this example, transmitter module 304 and receiver module 306 are communicatively coupled to a plurality of transmitter electrodes 303 and a plurality of receiver electrodes 305, respectively. In other embodiments, other communicative couplings between processing system 310 and sensor electrode 302 are possible. For example, some embodiments comprise combination sensor electrodes in place of or in addition to dedicated transmitter and receiver electrodes; the combination electrodes are configured as both transmitter and receiver sensor electrodes, and the transmitter and receiver modules are both communicatively coupled to the same combination electrodes. As another example, some embodiments share hardware or software between the transmitter and receiver modules. As yet another example, in some embodiments sensor electrodes 302 may include only one transmitter electrode, only one receiver electrode, or only one of each (instead of pluralities of transmitter and receiver electrodes). In some embodiments, sensor electrodes 302 are configured as described above in conjunction with FIG. 2. In other embodiments, a variety of other sensor electrode configurations may be employed.

In general, transmitter module 304 includes transmitter circuitry (hardware) for operating the plurality of transmitter electrodes 303, and/or software as appropriate. In processing system 310, transmitter module 304 is configured to simultaneously transmit, using the plurality of transmitter electrodes 303, transmitter signals according to a plurality of digital codes. That is, the transmitter module 304 is configured to drive or otherwise operate the transmitter electrodes 303 to transmit different transmitter signals as defined by the different digital codes of the plurality of digital codes.

Each digital code of a plurality of digital codes comprises a sequence of elements, which may be scalar values for some digital codes. Transmitter signals may be transmitted according to a digital code in a variety of ways. For example, the elements of a digital code can be used to determine one or more aspects of the transmitter signal of a corresponding transmitter electrode over numerous time periods. Thus, different elements of the same digital code are associated with different time periods for the same transmitter electrode. In this example, different codes of the plurality of digital codes correspond to different transmitter electrodes. Example aspects of the transmitter signal that may be thus determined include any one or combination of: phase, frequency, amplitude, polarity, wave type, or any other appropriate aspect.

As another example, a digital code can be used to determine which of a set of transmitter electrodes transmit at a particular time, or how the set of transmitter electrodes transmit at a particular time. (“How” includes any of the aspects of transmitter signals described above.) In this latter example, the j^{th} elements of the codes of the plurality of digital codes all correspond to the same transmitter electrode, albeit at different time periods. That is, each code of the plurality of digital codes corresponds, in different time periods, to all transmitter electrodes of the set of transmitter electrodes.

In one embodiment of processing system 310, each digital code of the plurality of digital codes corresponds to a transmitter electrode of the plurality of transmitter electrodes; different elements of a digital code determine the polarity of the transmitter signal transmitted by the corresponding transmitter electrode. Thus, in different time periods, the transmitter module 340 modulates a transmitter electrode of the plurality of transmitter electrodes 303 with a positive or negative polarity as determined by elements of the corresponding digital code. As a specific example of this embodiment, in accordance with a digital code portion of the scalars [−1 0 +1], the transmitter module 340 modulates a corresponding transmitter electrode with a modulation having a negative polarity for a first time period, followed by no modulation for a second time period, followed by a modulation having a positive polarity for a third time period.

In some embodiments, the transmitter module 304 is configured to simultaneously transmit, using the plurality of transmitter electrodes 303, transmitter signals according to a plurality of substantially orthogonal digital codes. A plurality of substantially orthogonal digital codes is a plurality of codes where each code of the plurality is substantially orthogonal to all other codes of the plurality. Substantially orthogonal codes are often preferred for transcapacitive input devices that produce capacitive images of the input in the sensing region, for their relatively uniform SNR (signal-to-noise ratio) improvement in capacitive images in the presence of white Gaussian noise (WGN). In some embodiments, codes that are not substantially orthogonal may generate non-uniform SNR improvement in capacitive images in the presence of WGN.

In some embodiments, the transmitter module 304 is configured to simultaneously transmit, using the plurality of transmitter electrodes 303, transmitter signals according to a plurality of significantly non-orthogonal digital codes. A plurality of significantly non-orthogonal digital codes is a plurality of codes where at least two codes of the plurality of significantly non-orthogonal digital codes are significantly non-orthogonal. Thus, a plurality of significantly non-orthogonal digital codes may have two or more digital codes that are substantially orthogonal to each other, as long as at least two codes are significantly non-orthogonal.

Further discussions of orthogonality and methods to quantify orthogonality are discussed below.

Receiver module 306 includes any combination of software and/or hardware configured to receive, with the plurality of receiver electrodes 305, a plurality of resulting signals. In some embodiments, each resulting signal of the plurality of resulting signals comprises multiple effects corresponding to multiple transmitter signals of the plurality of transmitter signals. That is, the plurality of transmitters 303 transmit multiple transmitter signals simultaneously, such that a resulting signal received by a receiver electrode of the plurality of receiver electrodes 305 is affected by multiple, simultaneous transmissions.

Determination module 306 includes any combination of hardware and/or software configured to determine object information for input in the sensing region of the transcapacitive input device, using the plurality of resulting signals received by the plurality of receiver electrodes 305. Object information can be information about any characteristic of input detected by the transcapacitive sensor device. Example types of object information include: object shape, object size, number of objects, configuration of objects (e.g., open hand vs. closed hand), relative locations or distances between objects, position or other positional information about one or more objects, and the like. Determination module 306 can be configured to use the plurality of resulting signals in any appropriate way to determine object information. In some embodiments, determination module 306 is configured to use the plurality of resulting signals by determining object information based on a comparison of the resulting signals to a family of expected signals.

In some embodiments, determination module 306 compares the resulting signals to a family of expected signals by correlating the resulting signals with a family of expected signals. In some embodiments, the correlation may be performed on conditioned versions of the resulting signals instead of the raw resulting signals. The conditioned versions of the resulting signals may be derived from the resulting signals through any one or combination of noise conditioning, averaging, integrating, removal of a baseline (such that the conditioned version indicates a change from a baseline value), or other appropriate signal processing steps. In all cases, each conditioned version of a resulting signal comprises multiple effects corresponding to the multiple transmitter signals of the plurality of transmitter signals. Thus, conditioned versions of the plurality of resulting signals are not formed by demodulating the plurality of resulting signals using the plurality of digital codes used to determine the plurality of transmitter signals. In some embodiments, conditioned versions of the plurality of resulting signals are reflective of changes in capacitance coupling between the corresponding receiver electrode of the plurality of receiver electrodes 305 and the plurality of transmitter electrodes 303.

In some embodiments, determination module 306 compares the resulting signals to a family of expected signals by determining correlation amounts between the resulting signals and different expected signals (different members) of a family of expected signals, and by determining a highest correlation or a set of correlations exceeding (i.e., past) a threshold correlation amount based on the correlation amounts. Determination module 306 may determine correlation amounts between the resulting signals and different expected signals by correlating conditioned versions of the resulting signals with the expected signals. Some embodiments that determine a highest correlation may identify a value of the highest correlation amount, identify which of the expected signals (which member) corresponds to the highest correlation amount, or identify the input (or one or more characteristics of the input, such as position, shape, size, type, etc.) associated with the expected signals corresponding to the highest correlation amount. In some embodiments, the highest correlation may be determined through various interpolation or extrapolation methods, as appropriate. Similarly, some embodiments that determine a set of correlations exceeding a threshold correlation amount based on the correlation amounts may identify values of the set of amounts, identify which expected signals (which members) correspond to the set of amounts, or identify the input (or one or more characteristics of the input) associated with the set of amounts.

Thus, in some embodiments, determination module 306 determines object information based on a comparison of the resulting signals to a family of expected signals. A family of expected signals comprises different expected signals associated with different inputs. In various embodiments, the family of expected signals corresponds to the expected signals anticipated in response to particular types of input objects in particular configurations and at particular locations with respect to the sensing region of the transcapacitive sensor device. The family of expected signals may, for example, differ in expected object size, expected object shape, expected object positions, any other input characteristic, or combinations thereof. By comparing the resulting signals to such expected signals, and determining which set of expected signals sufficiently or best match the signals actually obtained, object information can be determined.

The family of expected signals may be determined empirically, analytically, or through a combined empirical/analytical approach. In some embodiments, determining the family of expected signals empirically entails taking readings associated with different input objects interacting with an input device operating in the manner expected (e.g., with a particular plurality of digital codes). The resulting signals for a particular input object interacting in a particular way with such a device can then be used to provide the expected signal for such input object interacting with such a way for that device operating in that way, and to similar devices.

In some embodiments, a smaller set of readings are obtained using experimental methods, and used to generate a larger set of expected signals. For example, readings for input objects of three sizes may be extrapolated or interpolated to produce expected signals for additional sizes. As another example, readings for a single input object over multiple locations of the sensing region may, for select pluralities of digital codes and contexts of operation, be superimposed to generate expected signals for multiple input objects simultaneously in the sensing region.

In some embodiments, templates are used in conjunction with a plurality of digital codes s to generate the expected signals for that plurality of digital codes in part or in whole. A “template” as used herein refers to anticipated changes in capacitance in response to particular input. For example, a stylus and a finger at a same location in the sensing region of the transcapacitive touch sensor device are associated with two different templates. As another example, a particular stylus hovering at a same non-contact distance from a touch surface of the transcapacitive touch sensor device would be associated with a different template for each different X-Y hover location.

As a specific example of template use, a finger hovering above a particular X-Y location of a sensing region of a transcapacitive sensor device causes particular changes in capacitive coupling. For a transcapacitive sensor device embodiment comprising orthogonally disposed sensor electrodes, the changes in capacitive coupling might be characterized by a sub-template comprising a 5×5 matrix of real values. Normalized to a peak value of 1.0, the subtemplate may look as follows:

$$( \begin{matrix}0.32 & 0.45 & 0.46 & 0.45 & 0.32 \\ 0.45 & 0.69 & 0.81 & 0.69 & 0.45 \\ 0.46 & 0.81 & 1.00 & 0.81 & 0.46 \\ 0.45 & 0.69 & 0.81 & 0.69 & 0.45 \\ 0.32 & 0.45 & 0.46 & 0.45 & 0.32\end{matrix} )$$

A template of a finger hovering over a central location of a similar transcapacitive sensor device with more than 5 transmitters may be generated by adding zeroes as appropriate. For example, a subtemplate such as the above may be augmented with 13 zeroes in the X direction (6 zeroes on one side and 7 zeroes on the other) and 6 zeroes in the Y direction (3 on each side) to produce a template of a finger hovering over a central location of a transcapacitive sensor device with 18 receivers spanning the X direction and 11 transmitters spanning the Y direction.

A graphical depiction 400 of such an 18×11 template is shown in FIG. 4. The x and y axes correspond, respectively, to particular receiver electrodes and transmitter electrodes, and the z axis corresponds to a normalized value of change in capacitance. Placing the subtemplate at different locations other than the central location shown would generate different templates reflective of the same hovering finger located over different X-Y locations of the sensing region. To simulate this hovering finger at an edge of the sensing region, the subtemplate may be centered near or over an edge, and portions that extend beyond the sensing region cropped. Similarly, to simulate the finger hovering over a smaller sensing region that is smaller than 5×5, the overhanging portions of the subtemplate may be cropped.

While the illustrated example above depicts a 5×5 subtemplate, other types of input may correspond to smaller templates (e.g., 3×3, 4×4) or larger templates (e.g., 6×6, 7×7, etc.). Furthermore, depending on the input, a template may comprise a non-square array, be rectangular or elliptical or complex in shape, and comprise linear or nonlinear edges.

A template can be used with a model of a transcapacitive sensor device to generate corresponding expected signals. For example, a template of how capacitance changes in response to a particular input can be used with a model of how the transcapacitive sensor device responds to changes in capacitance at different locations to generate the expected signals for that particular input. Transcapacitive sensor device models can be developed through experiments with analytical and electrical models, with or without the aid of computers.

As a specific example, where FIG. 4 is a representation of a template S corresponding to a finger hovering at the location shown, and FIG. 5 is a normalized representation of the expected signals MS corresponding to the template S, where the excitation matrix M combines the digital codes of the plurality of digital codes as detailed above.

A “family” of templates refers to two or more templates that can be used to determine a characteristic of the input. For example, a family of templates may be used to determine input object shape(s), input object size(s), input object position, or some other input characteristic. These families of templates can be used with models of transcapacitive sensor devices to generate corresponding families of expected signals. As a specific example, families may correspond to inputs such as hovering small finger, hovering larger finger, stylus in contact, palm in contact, etc., through all possible positions. In one embodiment, a family of expected signals is created from a family of templates {Sᵢ}, where the different templates correspond to different finger hover locations.

In some embodiments, the families of expected signals are pre-calculated and stored in a memory accessible by the processing system 310. In some embodiments, sub-templates or templates are stored in a memory accessible by the processing system 310 and used to determine expected signals dynamically.

Various metrics may be used for comparing resulting signals (such as those received by the receiver electrodes 305) to expected signals. In various embodiments, correlation amounts are determined through inner products of conditioned versions of the resulting signals and the expected signals. Returning to the example shown in FIGS. 4 and 5, a correlation amount of the template shown in FIG. 4 to measured changes in capacitive coupling, or a correlation amount of the expected values shown in FIG. 5 to conditioned versions of corresponding the expected signals, can be computed. In some embodiments, this computation comprises taking the inner product of the expected signals (noted here as M·S) and the actual signals (noted here as M·ΔC), where S is the template written as a one-dimensional vector, M is the excitation matrix, and M·ΔC is the conditioned versions of the resulting signals. In an embodiment, the rows of M indicate which transmitters are active for a measurement as well as the polarity of the excitation. Higher values indicate higher correlation, and lower values indicate lower correlation. This correlation computation can be termed a “matched filter” operation, and correlates measured signals with anticipated signals to detect the presence of the anticipated signals in the measured signals.

Referring now to FIG. 6 in conjunction with FIG. 3, a method 600 in accordance with one embodiment will now be briefly described. First, in step 602, the processing system simultaneously transmits, using the plurality of the transmitter electrodes 303, a plurality of transmitter signals in accordance with a plurality of significantly non-orthogonal digital codes. At least two codes of the plurality of significantly non-orthogonal digital codes are significantly non-orthogonal. In step 604, the processing system receives a plurality of resulting signals at the receiver electrodes 305. Each resulting signal of the plurality of resulting signals comprises multiple effects corresponding to multiple transmitter signals of the plurality of transmitter signals. In step 606, the processing system determines object information for input in the sensing region using the resulting signals. In some embodiments, the processing system determines object information such as position. In some embodiments, the processing system determines object information based on a comparison of the resulting signals to a family of expected signals.

The plurality of digital codes used with the processing system 310 or the method 600 may be a plurality of significantly non-orthogonal digital codes. As used herein, the phrase “a plurality of significantly non-orthogonal digital codes” refers to sets of digital codes that are not sets of substantially orthogonal digital codes.

Substantially orthogonal digital codes comprise strictly orthogonal digital codes and digital codes which nearly approximate strictly orthogonal codes. Digital codes that are strictly orthogonal codes have zero cross-correlation, and substantially orthogonal codes have low correlation. Significantly non-orthogonal codes are codes that depart from orthogonality to a significant degree.

Generally, the orthogonality of digital codes may be understood as being analogous to the orthogonality of vectors. For example, the angle θ between two vectors, a=(a₁, a₂, a₃, . . . , a_{N}) and b=(b₁, b₂, b₃, . . . , b_{N}), is related to the dot product of the two vectors by the equation:

$$cos θ = \frac{〈 a , b 〉}{‖ a ‖ ‖ b ‖}$$

where [symbol] •,• [symbol] is the dot product defined by [symbol] a, b [symbol] =Σ^{N}ᵢ₌₁ aᵢbᵢ, and ∥•∥ is the vector norm defined by ∥a∥=\sqrt{ [symbol]a, a [symbol]}. Two non-zero vectors a and b are strictly orthogonal if the angle θ between them equals 90°. This occurs when the dot product [symbol] a, b [symbol] is zero. Two vectors are substantially orthogonal when the angle between them is substantially equal to 90° and when their dot product normalized by the vectors' lengths is close to zero.

Some digital codes derived from maximal length sequences (MLS) form an example plurality of substantially orthogonal digital codes. Consider the following plurality of 15 digital codes derived from a length 15 MLS:
a₁=(1,1,1,−1,−1,−1,1,−1,−1,1,1,−1,1,−1,1).

A pair of digital codes may be derived by cyclically shifting this code. For example, another member of the corresponding set of digital codes is generated by shifting the first “1” to the end of the sequence:
b₁=(1,1−1,−1,−1,1,−1,−1,1,1,−1,1,−1,1,1).

Accordingly, for codes a₁ and b₁,

$$cos θ = \frac{〈 a , b 〉}{‖ a ‖ ‖ b ‖} = \frac{- 1}{\sqrt{15} \cdot \sqrt{15}} ,$$

and θ≈93.8°, so these two codes a and b are substantially orthogonal to each other. The angles θi between all other pairs of codes produced by cyclically shifting a₁ by different amounts are also substantially equal to 90°, and thus this plurality of digital codes is substantially orthogonal.

In contrast, consider a second plurality of 15 digital codes derived by cyclically shifting the length 15 sequence below:
a₂=(1,1,1,1,1,1,1,1,−1,−1,−1,−1,−1,−1,−1).

A second member of this second plurality is generated by shifting the first “1” to the end of the sequence:
b₂=(1,1,1,1,1,1,1,−1,−1,−1,−1,−1,−1,−1,1).

Using the dot product equation above, for codes a₂ and b₂, θ can be computed as 42.8°. Thus, at least these two codes of the second plurality of digital codes are not substantially orthogonal to each other, as the angle between them is not substantially equal to 90°. Thus, this second plurality of digital codes is significantly non-orthogonal.

What is considered substantially orthogonal, and what is considered significantly non-orthogonal, varies with operating context. However, in some embodiments, pluralities of significantly non-orthogonal digital codes each contain at least two codes which are separated by no more than 70°. In some embodiments, pluralities of significantly non-orthogonal digital codes each contain at least two codes which are separated by no more than 60°. In some embodiments, pluralities of significantly non-orthogonal digital codes each contain at least two codes which are separated by no more than 50°. In some embodiments, pluralities of significantly non-orthogonal digital codes each contain at least two codes which are separated by no more than 45°.

Pluralities of orthogonal, substantially orthogonal, and significantly non-orthogonal codes may be generated and selected in a variety of ways.

In one embodiment, the set of digital codes has the characteristic that each element of each digital code is selected from the set {−1, 0, +1}. Fewer options for values can simplify operation in response to the code. For example, where the elements of the code determine the polarity of transmitter modulation and corresponding transmitter signal, limiting the values to −1, 0, +1 limits the transmitter modulation to states that generate transmitter signals with one type of negative polarity, no modulation, and one type of positive polarity.

In one embodiment, each digital code of the plurality of digital codes is a cyclic shift of the first digital code in the set, such that any two codes of the plurality of digital codes are cyclically shifted versions of each other. That is, all of the codes (aside from the first digital code) contain elements ordered in the form of an unbroken circle between a beginning and an end of a code. Different codes begin at different parts of the circle, and proceed through the circle in the same direction. In embodiments where the length of the code, that is, the number of elements in the code, corresponds to the number of transmitters, all of the digital codes that form the set of digital codes are defined by any one of the digital codes within the set of digital codes. How the codes correspond to the transmitter electrodes, or in what order the codes are applied, can be determined separately.

In one embodiment where the codes of the plurality of digital codes each correspond to a transmitter electrode and the element of the code is associated with transmitter signal polarity, the codes have the characteristic that the sum of the jth element of each code is small, for all values of j. Thus, at all times, a similar number of transmitters are transmitting signals of positive polarity as well as negative polarity. In various embodiments, this reduces the amplitude range associated with resulting signals received by the receiver electrodes, and may facilitate implementation of the receiver module (e.g., receiver module 306). In some embodiments where the elements of the codes are selected from the set {−1, 0, +1} or {−1, +1}, the number of −1s and the number of +1s at any jth position in the code is no more than two.

Thus, in some embodiments, the codes are configured to cause the transmitter module to simultaneously transmit, using the plurality of transmitter electrodes, by modulating a first set of the plurality of transmitter electrodes with a positive polarity during a time period, and modulating a second set of the plurality of transmitter electrodes with a negative polarity during the time period. Further, in these embodiments, the first set and the second set differ in size by no more than two transmitter electrodes (e.g., are equal and differ by zero, or differ by one or two).

In one embodiment, the set of digital codes has the characteristic that the signal-to-noise ratio (SNR) associated with a family of expected signals is relatively higher. Referring again to FIG. 5 for discussion of M and S, the SNR associated with expected signals S in the presence of white Gaussian noise is proportional to ∥M·S∥², where S and M are as described above.

Specific examples of pluralities of significantly non-orthogonal digital codes include the following. These examples have the characteristics that: (1) each element of the digital code is selected from the set of {−1,0,+1}; (2) each code is the cyclic shift of the first code; (3) the sums of jth elements are small; and (4) the digital codes reduce the SNR of a family of expected signals based on the 5×5 template previously described in conjunction with FIG. 4 in the presence of white Gaussian noise. A first example code is (1,1,1,1,1,−1,−1,−1,−1) for nine transmitters, a second example code is (1,1,1,1,1,−1,−1,−1,−1,−1) for ten transmitters, and a third example code is (1,1,1,1,1,1,−1,−1,−1,−1,−1) for eleven transmitters. These are three example codes; however, other codes with the four characteristics outlined, with a subset of the four characteristics outlined, or with other characteristics are also contemplated.

Returning to the nine transmitter code example, the nine transmitters each have a different code selected from the cyclic set: (1,1,1,1,1,−1,−1,−1,−1), (1,1,1,1,−1,−1,−1,−1,1), (1,1,1,−1,−1,−1,−1,1,1), (1,1,−1,−1,−1,−1,1,1,1), (1,−1,−1,−1,−1,1,1,1,1), (−1,−1,−1,−1,1,1,1,1,1), (−1,−1,−1,1,1,1,1,1,−1), (−1,−1,1,1,1,1,1,−1,−1), (−1,1,1,1,1,1,−1,−1,−1). These different codes may be assigned to different transmitter electrodes without any specific correlation to their physical position. Alternatively, these different codes may be assigned in order to different transmitter electrodes based on a spatial ordering of the transmitter electrodes. In some embodiments, these codes are assigned in such a way that contiguous chunks of 1s and −1s are assigned to contiguous chunks of transmitter electrodes in physical implementation. Thus, some adjacent transmitter electrodes of the plurality of transmitter electrodes transmit with the same polarity, and the transmitter electrodes transmitting with the same polarity form a contiguous set. This approach can be extended to the ten and eleven transmitter examples described above.

As can be seen by the above examples, it is advantageous in some embodiments for the transmitter module 304 to be configured to modulate a first set of transmitter electrodes with a positive polarity during a time period, and modulate a second set of transmitter electrodes (e.g., a different set of transmitter electrodes) with a negative polarity during the same time period. The first set or the second set (or both) may comprise a non-contiguous set of transmitter electrodes, or a set of adjacent transmitter electrodes that form a contiguous set of transmitter electrodes. In general, the first and second sets are non-overlapping sets. In some embodiments, the sizes of the first and second sets differ by no more than two—that is, they are equal, differ by one, or differ by two. In some embodiments, the sizes of the sets differ by a greater number. In some embodiments, all of the transmitter electrodes of the plurality of transmitter electrodes 303 are modulated with either positive or negative polarities. In some embodiments, the union of the first and second sets is not the full plurality of transmitter electrodes, and the plurality of significantly non-orthogonal digital codes is further configured such that the transmitter module 304 does not modulate a third set of the plurality of transmitter electrodes during the same time period. In some embodiments, the third set includes no more than two transmitter electrodes, and is located between the first and second set.

Note that the terms “positive” and “negative” as used in connection with a particular polarity are not necessarily intended to denote strictly positive or negative values (although some embodiments do use zero reference values). In some embodiments, “positive” and “negative” denote polarity with respect to non-zero reference values.

In one embodiment, the transmitter module 304 is further configured to simultaneously transmit, using the transmitter electrodes 303, a second plurality of transmitter signals according to a second plurality of digital codes different from the plurality of digital codes. The second plurality of digital codes may be a plurality of significantly non-orthogonal codes, or a plurality of substantially orthogonal codes. For example, some embodiments utilize a plurality of significantly non-orthogonal codes in a first, non-capacitive-imaging mode, and another plurality of codes for a second, capacitive imaging mode, where a capacitive image directly indicative of capacitive coupling at each capacitive pixel is computed. In some embodiments, other pluralities of significantly non-orthogonal codes may be applied in other modes, imaging or not imaging.

In one embodiment, the transmitter module 304 is configured to simultaneously transmit, using the transmitter electrodes 303, transmitter signals based on a second plurality of digital codes to sense an input object in a first portion of the sensing region, wherein the second plurality of digital codes is different from the first plurality of digital codes. Stated another way, it may be useful in some embodiments to utilize one set of codes for one portion of the sensing region, and another set of codes for another portion of the sensing region.

In summary, what has been disclosed are methods and apparatus for using expected signals in conjunction with pluralities of digital codes to improve proximity sensing.

Thus, the embodiments and examples set forth herein were presented in order to explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A transcapacitive sensor device comprising:
a plurality of transmitter electrodes;
a plurality of receiver electrodes capacitively coupled with the plurality of transmitter electrodes; and
a processing system communicatively coupled to the plurality of transmitter electrodes and the plurality of receiver electrodes, the processing system configured to:
transmit, with the plurality of transmitter electrodes, a plurality of transmitter signals in accordance with a plurality of significantly non-orthogonal digital codes, wherein at least two codes of the plurality of significantly non-orthogonal digital codes are significantly non-orthogonal;
receive, with the plurality of receiver electrodes, a plurality of resulting signals, each resulting signal of the plurality of resulting signals comprising multiple effects corresponding to multiple transmitter signals of the plurality of transmitter signals; and
determine one or more positions for input near the pluralities of transmitter and receiver electrodes based on a comparison of the plurality of resulting signals with a family of expected signals by:
determining correlation amounts between the plurality of resulting signals and different members of the family of expected signals, and
determining, based on the correlation amounts, a highest correlation or a set of correlations exceeding a threshold correlation amount.

2. The transcapacitive sensor device of claim 1, wherein at least two digital codes of the plurality of significantly non-orthogonal digital codes are cyclically shifted versions of each other.

3. The transcapacitive sensor device of claim 1, wherein the processing system is configured to transmit the plurality of transmitter signals transmitter signals in accordance with the plurality of significantly non-orthogonal digital codes by:
modulating a first set of the plurality of transmitter electrodes with a positive polarity during a time period; and
modulating a second set of the plurality of transmitter electrodes with a negative polarity during the time period, wherein the first set and the second set differ in size by no more than two transmitter electrodes, and wherein at least one set selected from the group consisting of the first set and the second set comprises a contiguous set of transmitter electrodes.

4. A processing system for a transcapacitive input device comprising a plurality of transmitter electrodes and a plurality of receiver electrodes, the processing system comprising:
a transmitter module including transmitter circuitry, the transmitter module configured to simultaneously transmit, using the plurality of transmitter electrodes, a plurality of transmitter signals according to a plurality of significantly non-orthogonal digital codes, wherein at least two codes of the plurality of significantly non-orthogonal digital codes are significantly non-orthogonal;
a receiver module, the receiver module configured to receive, with the plurality of receiver electrodes, a plurality of resulting signals, each resulting signal of the plurality of resulting signals comprising multiple effects corresponding to multiple transmitter signals of the plurality of transmitter signals; and
a determination module configured to determine object information for input in the sensing region using the plurality of resulting signals.

5. The processing system of claim 4, wherein at least two digital codes of the plurality of significantly non-orthogonal digital codes are substantially orthogonal.

6. The processing system of claim 4, wherein at least two digital codes of the plurality of significantly non-orthogonal digital codes are cyclically shifted versions of each other.

7. The processing system of claim 4, wherein the plurality of significantly non-orthogonal digital codes is configured such that the transmitter module simultaneously transmits using the plurality of transmitter electrodes by:
modulating a first set of the plurality of transmitter electrodes with a positive polarity during a time period, and
modulating a second set of the plurality of transmitter electrodes with a negative polarity during the time period, wherein the first set and the second set differ in size by no more than two transmitter electrodes.

8. The processing system of claim 7, wherein the plurality of significantly non-orthogonal digital codes is further configured such that the transmitter module further simultaneously transmits using the plurality of transmitter electrodes by:
not modulating a third set of the plurality of transmitter electrodes during the time period.

9. The processing system of claim 4, wherein the plurality of significantly non-orthogonal digital codes is configured such that the transmitter module simultaneously transmits using the plurality of transmitter electrodes by:
modulating a first set of the plurality of transmitter electrodes with a positive polarity during a time period, and
modulating a second set of the plurality of transmitter electrodes with a negative polarity during the time period, wherein at least one set selected from the group consisting of the first set and the second set is a contiguous set of transmitter electrodes.

10. The processing system of claim 4, wherein the determination module is configured to determine object information for input objects in the sensing region based on the resulting signals by:
correlating the resulting signals with a family of expected signals, or
correlating conditioned versions of the resulting signals with members of the family of expected signals.

11. The processing system of claim 10, wherein expected signals of the family of expected signals differ in expected object size or expected object shape.

12. The processing system of claim 10, wherein expected signals of the family of expected signals differ in expected object position.

13. The processing system of claim 4, wherein the transmitter module is further configured to simultaneously transmit, using the plurality of transmitter electrodes, a second plurality of transmitter signals according to a second plurality of digital codes different from the plurality of significantly non-orthogonal digital codes.

14. The processing system of claim 13, wherein each code of the second plurality of digital codes is substantially orthogonal to all other codes of the second plurality of digital codes.

15. A method for detecting input objects in a sensing region of a transcapacitive input device comprising a plurality of transmitter electrodes and a plurality of receiver electrodes, the method comprising:
simultaneously transmitting, with the plurality of transmitter electrodes, a plurality of transmitter signals in accordance with a plurality of significantly non-orthogonal digital codes, wherein at least two codes of the plurality of significantly non-orthogonal digital codes are significantly non-orthogonal;
receiving, with the plurality of receiver electrodes, a plurality of resulting signals, each resulting signal of the plurality of resulting signals comprising multiple effects corresponding to multiple transmitter signals of the plurality of transmitter signals; and
determining object information for input in the sensing region based on a comparison of the resulting signals to a family of expected signals.

16. The method of claim 15, wherein at least two digital codes of the plurality of significantly non-orthogonal digital codes are cyclically shifted versions of each other.

17. The method of claim 15, wherein the simultaneous transmitting the plurality of transmitter signals in accordance with the plurality of significantly non-orthogonal digital codes comprises:
modulating a first set of the plurality of transmitter electrodes with a positive polarity during a time period; and
modulating a second set of the plurality of transmitter electrodes with a negative polarity during the time period, wherein the first set and the second set differ in size by no more than two transmitter electrodes.

18. The method of claim 17, wherein the first set of transmitter electrodes or the second set of transmitter electrodes is a contiguous set.

19. The method of claim 15, wherein the determining object information for input in the sensing region based on the comparison of the resulting signals to a family of expected signals comprises:
determining correlation amounts between the resulting signals and different members of the family of expected signals by correlating conditioned versions of the resulting signals with the expected signals, wherein the different members of the family of expected signals differ in at least one object characteristic selected from the group consisting of: expected object size, expected object shape, and expected object location; and
determining, based on the correlation amounts, a highest correlation or a set of correlations exceeding a threshold correlation amount.

20. The method of claim 15, further comprising:
simultaneously transmitting, with the plurality of transmitter electrodes, a second plurality of transmitter signals in accordance with a plurality of substantially orthogonal digital codes, wherein each code of the plurality of substantially orthogonal digital codes is substantially orthogonal to all other codes of the plurality of substantially orthogonal digital codes.
